(19) United States
(12) Patent Application Publication
(10) Pub. No.: US 2019/0366349 A1
(43) Pub. Date: Dec. 5, 2019

(54) Rock Crusher for a Potato Harvester

(71) Applicant: Luc Levesque, Saint-Andre (CA)

(72) Inventor: Luc Levesque, Saint-Andre (CA)

(21) Appl. No.: 15/932,951

(22) Filed: May 30, 2018

(51) Int. Cl. B02C 13/06; B02C 13/288; B02C 23/18; B02C 13/30; A01D 33/00

(52) U.S. Cl. CPC B02C 13/06; B02C 13/288; A01D 33/00; B02C 13/30; B02C 23/18

(57) ABSTRACT

The rock crusher has hammers mounted to a rotor and anvils mounted to its casing. First and second anvil sets define a convex surface arrangement facing the rotor and second and third anvil sets define a concave surface arrangement facing the rotor. The anvil sets are oriented to reduce compaction of rocks in the infeed portion of the crusher, and to reduce compaction of aggregate in the casing of the rock crusher. In relation to the movement of each hammer along their work sector, the two operations mentioned above are carried out before a third portion of the work sector wherein rocks are directed to rebound and impact the hammers head-on along the work circle of the hammers. The rock crusher is directly driven by the engine of a potato harvester, wherein the engine, the fan of the harvester and the rock crusher share a common inertia.

### FIELD OF THE INVENTION

This invention pertains to rock crushers and more particularly, it pertains to an impact-type rock crusher mounted to a potato harvester for breaking potato-size rocks that are picked up by the harvester.

### BACKGROUND

The crushing of rocks is one of the most ancient technologies existing. The crushing of rocks is also one of the most complicated endeavor. The efficiency of a rock crusher depends on the quantity and size of rocks being fed to the crusher. The efficiency is also affected by the retention time of each rock inside the crusher, and the retention time of broken rock pieces, gravel and sand inside the crusher. The speed of rotation of the rotor is equally important, as well as the mass of the rotor, and the location of the anvils relative to the rotor.

Rocks are broken inside an impact-type crusher by direct impact with a hammer, by impact against an anvil, by impact with another rock, by impact between an anvil and a hammer, or by several impacts and rebounds inside the crusher.

The design of an impact-type rock crusher is more of an art than a precise science. The exact trajectory of a rock inside a crusher is impossible to predict, and the number of blows required to break a rock can only be estimated. It is believed that the existing impact-type rock crushers have been developed by experienced craftsperson, by trial-and-error and through accumulations of small improvements.

The following documents represent a good inventory of impact-type rock crushers available in the prior art.

U.S. Pat. No. 1,354,855 issued to J. G. Simpson on Oct. 5, 1920;
U.S. Pat. No. 1,469,877 issued to J. K. Blum on Oct. 9, 1923;
U.S. Pat. No. 1,621,938 issued to W. K. Liggett on Mar. 22, 1927;
U.S. Pat. No. 1,872,233 issued to G. W. Borton on Aug. 16, 1932;
U.S. Pat. No. 2,287,799 issued to S. D. Hartshorn on Jun. 30, 1942;
U.S. Pat. No. 2,373,691 issued to L. H. Kessler on Apr. 17, 1945;
U.S. Pat. No. 2,618,438 issued to J. Chrystal on Nov. 18, 1952;
U.S. Pat. No. 2,862,669 issued to F. W. Rollins on Dec. 2, 1958;
U.S. Pat. No. 2,891,734 issued to E. O. W. F. Andreas on Jun. 23, 1959;
U.S. Pat. No. 2,958,474 issued to L. J. Meyer on Nov. 1, 1960;
U.S. Pat. No. 3,146,959 issued to C. P. Putnam, Jr. on Sep. 1, 1964;
U.S. Pat. No. 3,278,126 issued to T. A. Ratkowski on Oct. 11, 1966;
U.S. Pat. No. 3,447,758 issued to N. Oznobichine on Jun. 3, 1969;
U.S. Pat. No. 3,455,517 issued to G. T. Gilbert on Jun. 15, 1969;
U.S. Pat. No. 3,531,055 issued to G. Alt on Sep. 29, 1970;
U.S. Pat. No. 3,608,841 issued to F. Wageneder on Sep. 28, 1971.
U.S. Pat. No. 3,659,794 issued to G. Hemesath on May 2, 1972;
U.S. Pat. No. 3,662,963 issued to O. B. McClure on May 16, 1972;
U.S. Pat. No. 3,667,694 issued to R. M. Williams on Jun. 6, 1972;
U.S. Pat. No. 3,931,937 issued to W. F. Hahn et al., on Jan. 13, 1976;
U.S. Pat. No. 3,987,971 issued to O. B. McClure on Oct. 26, 1976;
U.S. Pat. No. 4,017,035 issued to J. Stuttmann on Apr. 12, 1977;
U.S. Pat. No. 4,037,796 issued to P. M. Francis on Jul. 26, 1977;
U.S. Pat. No. 4,046,325 issued to S. Tucsok et al., on Sep. 6, 1977;
U.S. Pat. No. 4,049,206 issued to R. König et al., on Sep. 20, 1977;
U.S. Pat. No. 4,090,673 issued to S. B. Ackers et al., on May 23, 1978;
U.S. Pat. No. 4,140,284 issued to J. Jöbkes on Feb. 20, 1979;
U.S. Pat. No. 4,193,556 issued to W. Linnerz et al., on Mar. 18, 1980;
U.S. Pat. No. 4,361,290 issued to P. M. Francis on Nov. 30, 1982;
U.S. Pat. No. 4,373,678 issued to G. W. Reitter on Feb. 15, 1983;
U.S. Pat. No. 4,506,837 issued to H. Shrödl on Mar. 26, 1985;
U.S. Pat. No. 4,635,863 issued to F. M. McCorkel on Jan. 13, 1987;
U.S. Pat. No. 4,729,517 issued to W. Krokor et al., on Mar. 8, 1988;
U.S. Pat. No. 4,895,309 issued to L. Fritz on Jan. 23, 1990;
U.S. Pat. No. 5,226,604 issued to K-P. Seiffert et al., on Jul. 13, 1993;
U.S. Pat. No. 5,255,869 issued to R. G. Smith on Oct. 26, 1993;
U.S. Pat. No. 5,328,103 issued to E. B. Komarovsky on Jul. 12, 1994;
U.S. Pat. No. 5,482,218 issued to Y. Ha on Jan. 9, 1996;
U.S. Pat. No. 5,490,636 issued to H. Schrödl on Jan. 9, 1996;
U.S. Pat. No. 5,513,811 issued to H. Phan Hung on May 7, 1996;
U.S. Pat. No. 5,695,255 issued to M. LeBlond on Dec. 9, 1997;
U.S. Pat. No. 5,697,562 issued to M. LeBlond on Dec. 16, 1997;
U.S. Pat. No. 5,713,527 issued to G. Hemesath et al., on Feb. 3, 1998;
U.S. Pat. No. 5,875,980 issued to J. Schmid on Mar. 2, 1999;
U.S. Pat. No. 5,890,666 issued to K. Fölling et al., on Apr. 6, 1999.
U.S. Pat. No. 5,899,535 issued to M. LeBlond on May 4, 1999;
U.S. Pat. No. 5,921,484 issued to J. L. Smith et al., on Jul. 13, 1999;
U.S. Pat. No. 6,045,069 issued to W. G. Steed on Apr. 4, 2000;
U.S. Pat. No. 6,102,312 issued to D. H. Aberle on Aug. 15, 2000;
U.S. Pat. No. 6,637,680 issued to G. A. Young et al., on Oct. 28, 2003;
U.S. Pat. No. 6,745,966 issued to V. Heukamp on Jun. 8, 2004;
U.S. Pat. No. 7,278,596 issued to Y. Moriya et al., on Oct. 9, 2007;
U.S. Pat. No. 7,942,356 issued to R. Dallimore et al., on May 17, 2011;
U.S. Pat. No. 7,946,513 issued to J. O. Brick et al., on May 24, 2011;
U.S. Pat. No. 7,959,098 issued to J. Doppstadt et al., on Jun. 14, 2011;
U.S. Pat. No. 8,033,489 issued to I. Boast on Oct. 11, 2011;
U.S. Pat. No. 8,763,939 issued to A. E. Komarovsky et al., on Jul. 1, 2014;
U.S. Pat. No. 8,844,851 issued to M. Solomon on Sep. 30, 2014;
U.S. Pat. No. 8,967,504 issued to R. Dallimore et al., on Mar. 3, 2015;
U.S. Pat. No. 9,849,459 issued to T. J. M. Faure on Dec. 26, 2017;
US Patent Appl. 2009/0140089 published by I. Boast on Jun. 4, 2009;
US Patent Appl. 2013/0284839 published by T. Faure on Oct. 31, 2013;
GB Patent Appl. 2,020,574 published by A. Hofer on Nov. 21, 1979.

Although the rock crushers found in the prior art deserve undeniable merits, there continues to be a need for a rock crusher capable of efficiently handling a typical load of rocks picked up by a potato harvester. More specifically, there is a need for a rock crusher to be driven efficiently from the existing engine of a potato harvester without advertently taxing the power required to operate the harvester.

### SUMMARY

The rock crusher described herein have anvil sets that are oriented to reduce compaction of rocks in the infeed portion of the crusher, and to reduce compaction of aggregate and sand in the main body of the rock crusher. In relation to the movement of each hammer along their work sector, the decompression of the infeed and the main body are carried out before a third phase wherein rocks are directed to rebound and to impact the hammers head-on along the work circle of each hammer. The efficiency of the rock crusher is thereby improved.

In a first aspect, the rock crusher described herein has a casing, a rotor mounted in the casing, hammers mounted to the rotor and anvils mounted to the casing. The anvils include first, second and third anvil sets. The first and second anvil sets are aligned to define a convex surface arrangement facing the rotor and the second and third anvil sets are aligned to define a concave surface arrangement facing the rotor.

In another aspect, the first anvil set is oriented relative to the rotor for projecting rocks toward an infeed portion of the rock crusher; the second anvil set is oriented relative to the rotor for projecting rocks toward a discharge opening of the rock crusher, and the third anvil set is oriented relative to the rotor for projecting rocks toward a work circle of the rotor, against a direction of rotation of the rotor.

In yet another aspect, there is provided a method of breaking rocks in a rock crusher, comprising in series the steps of:
projecting rocks toward an infeed portion of the rock crusher;
projecting rocks toward a discharge opening of the rock crusher, and
projecting rocks toward a work circle of a rotor of the rock crusher against a direction of rotation of the rotor.

In yet a further aspect, there is provided a potato harvester comprising: an engine; a fan driven by the engine; a drive shaft also driven by the engine, and a rock crusher driven by the drive shaft. The fan; the drive shaft and the rock crusher are directly driven by the engine, so that the rock crusher shares with the fan and the engine a common inertia. Because of this large inertia, the rock crusher can handle larger load without slowing down.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the rock crusher according to the present invention is described herein with the aid of the accompanying drawings, in which like numerals denote like parts throughout the several views. The rock crusher according to the preferred embodiment of the present invention is referred to herein simply as the preferred rock crusher, for convenience. It will be appreciated that the preferred embodiment is presented for the purpose of explaining the best embodiment, and that other versions than the one illustrated are included in the intent and meaning of the claims.

FIG. 1 is a schematic illustration of a potato harvester with the rock crusher mounted under the end of the rock discharge conveyor of the harvester;

Table 1 provides dimensions to enable a person skilled in the art to build and use the preferred rock crusher efficiently;

FIG. 2 is a cross-section view of the rotor, the door and the anvils of the preferred rock crusher;

FIG. 3 is a perspective view of the hammer set, and one of the anvils mounted inside the preferred rock crusher;

FIG. 4 is a cross-section view of one of the hammers mounted inside the preferred rock crusher;

FIG. 5 is a cross-section view of one of the anvils mounted inside the preferred rock crusher;

FIG. 6 is a front view of the preferred rock crusher, and the door of the preferred rock crusher;

FIG. 7 is a partial right side view of the preferred rock crusher;

FIGS. 8 to 11 illustrate a second, third, fourth and fifth cross-section views of the rotor, the door and the anvils of the preferred rock crusher, showing preferred dimensions and specific regions therein;

FIG. 12 is a schematic illustration of the power transmission system for driving the preferred rock crusher.

The drawings presented herein are presented for convenience to explain the functions of all the elements included in the preferred embodiment of the present invention. Elements and details that are obvious to the person skilled in the art may not have been illustrated. Conceptual sketches have been used to illustrate elements that would be readily understood in the light of the present disclosure. These drawings are not fabrication drawings, and should not be scaled.

### DESCRIPTION OF THE PREFERRED EMBODIMENT

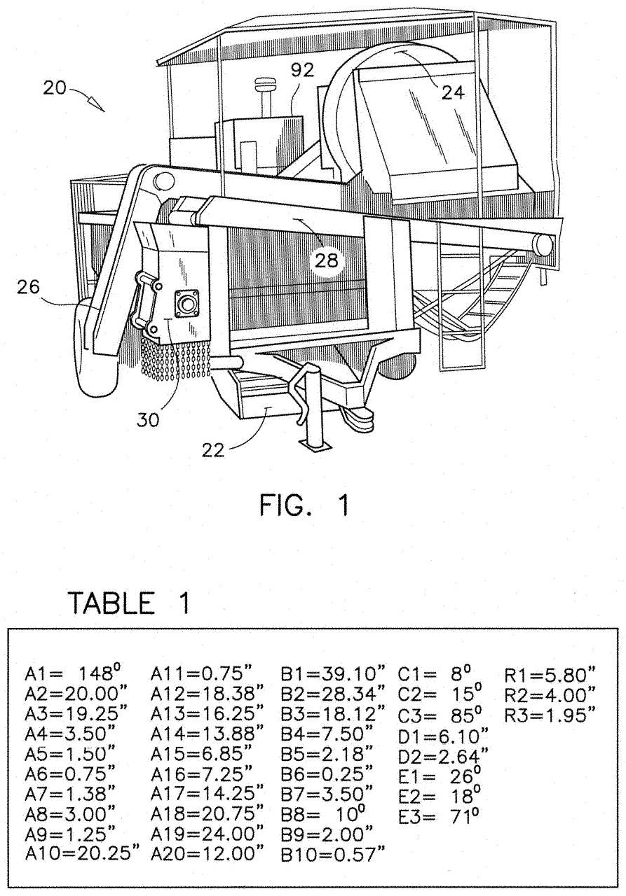

Referring firstly to FIG. 1, there is illustrated therein a potato harvester 20, using a digging scoop and conveyor assembly 22 for picking up potatoes off a field, and for shaking off soil from the potatoes as there are conveyed into the machine. The harvester 20 also has a large fan 24 mounted thereto for creating an air current across a gap (not shown) between two conveyors. The air stream from the fan 24 causes potatoes to float across the gap into an accept conveyor 26. The accept conveyor discharges into a truck (not shown) traveling alongside the harvester 20. The air stream from the fan 24 is strong enough to float tubers across the gap, but not enough to float rocks that are conveyed with the potatoes. The rocks fall through the gap into a reject conveyor 28. The reject conveyor 28 discharges into the preferred rock crusher 30 where these rocks are broken into small pieces such that they will not be picked up during the following harvest.

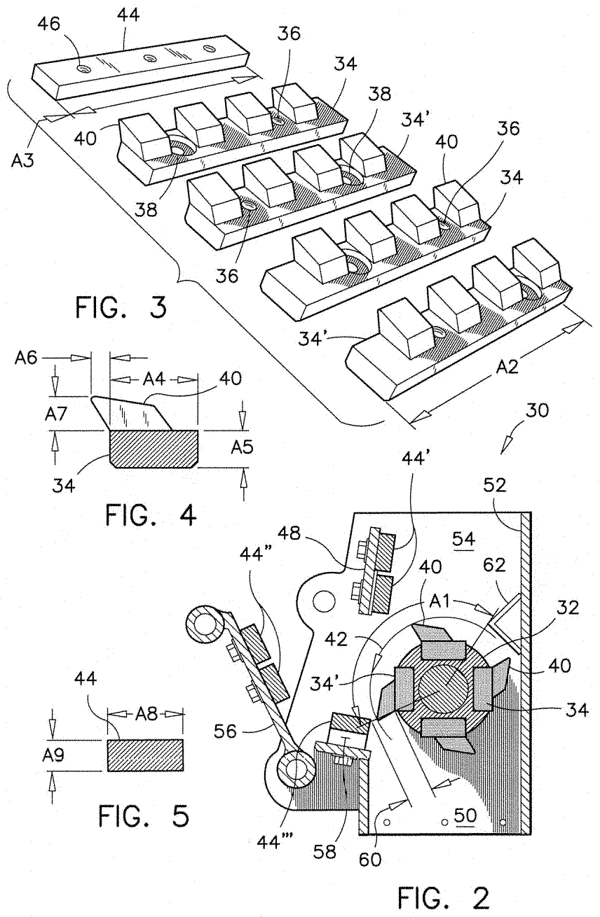

Referring to FIGS. 2-4, the preferred rock crusher 30 is made of a rotor 32 carrying four hammer bars 34. Each pair of hammer bars 34, 34′ is mounted to the rotor 32 with two bolts (not shown) extending diametrically in opposite directions through the rotor 32. One hole 36 in each of the hammer bars 34, 34′ is a threaded hole to accept one end of one bolt. The other hole 38 in each of the hammer bars 34, 34′ has a countersunk recess to protect the head of a respective bolt.

Each hammer bar 34, 34′ has four hammers 40 thereon. The hammers 40 on one bar are offset the width of one hammer in relation with the hammers 40 on the next bar when the bars 34, 34′ are mounted to the rotor 32. The rotation of the rotor 32 has a direction indicated by arrow 42 in FIG. 2.

Preferred dimensions for the bars 34, 34′ are shown in FIG. 4 and Table 1. Table 1 shows dimensions in inches and angles in degrees. The hammer bars 34, 34′ are made of hot-rolled steel with a hard facing of Teromatec® 4923 welding electrodes, by Castolin Eutectic®. Any rebuild after wear is done with hard surfacing EnDOtec® DO05 welding electrodes.

The preferred rock crusher 30 also comprises three groups of anvil bars 44. Each anvil bar 44 is a rectangular bar made of high strength impact-resistant steel having a hardness of 35 Rockwell™ or better. The anvil bars 44 have threaded holes 46 therein to accept mounting bolts (not shown). Preferred dimensions for the anvil bars 44 are also shown in FIG. 5 and Table 1.

The first set of anvil bars 44′ is mounted to a plate 48 above the rotor 32 and defines with the back plate 52 of the crusher housing an infeed chute 54. The infeed chute 54 has a size of about 12 inch by 20 inch. The second set of anvil bars 44″ is mounted against the inside surface of the door 56 of the preferred rock crusher 30. The third anvil bar set 44″′ is mounted to a shelf 58 below the door 56 of the crusher, and below the diameter of the rotor 32. The third anvil bar set 44″′ defines with the rotor 32 a discharge slot 60 across the width of the preferred rock crusher 30.

The infeed chute 54, the plate 48 above the door, the shelf 58 below the door, the back plate 52, the door 56 itself, and the side plates 50 enclosing the back plate constitute the casing of the preferred rock crusher 30.

A structural angle 62 is mounted above the rotor 32 in the infeed chute 54, to deflect the flow of rocks toward the axis of the rotor 32. The angle 62 and the third anvil set 44″′ define a total work sector “A1” of the rotor 32 wherein rocks are exposed to the hammers 40 of the rock crusher 30.

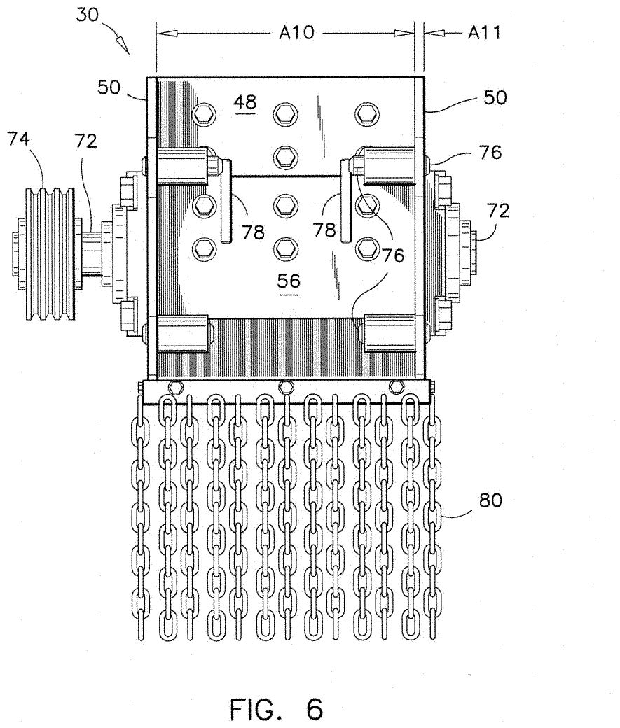

Referring to FIG. 6, the casing of th preferred rock crusher 30 is built with ¾ inch plate and has an infeed opening 54 width A10 of about 20¼ inches. The rotor is mounted on a 1.95 inch diameter shaft 72, which is driven by a multi-belt pulley 74. The door 56 of the crusher is mounted on four pins 76, two of which are movable by handles 78 to open the door 56. The purpose of the door 56 is for allowing the replacement of the hammer bars 34, 34′, and the anvil bars 44 when required, and to inspect the inside of the preferred rock crusher 30.

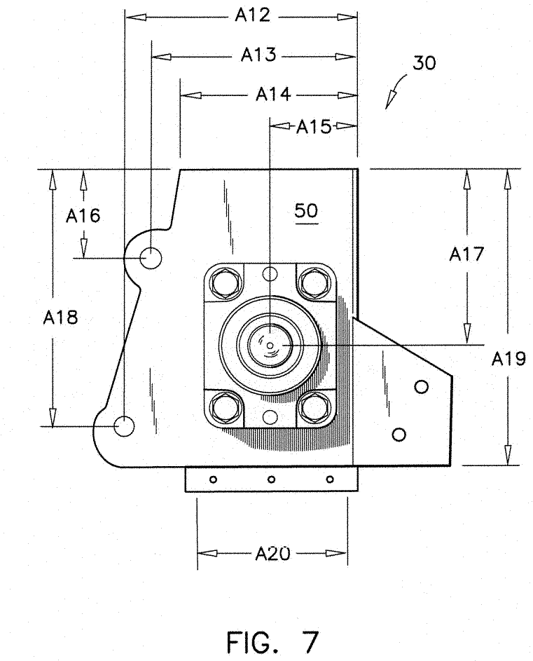

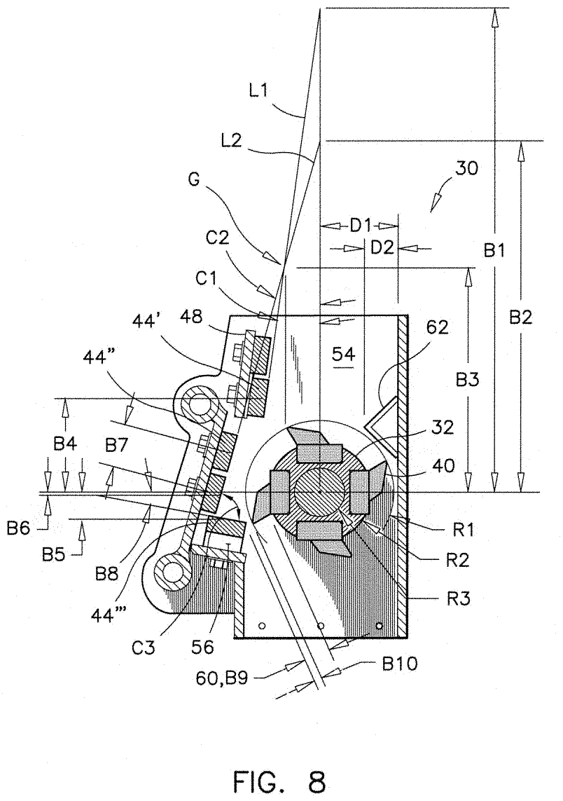

The preferred rock crusher 30 also has a chain-type curtain 80 extending around the discharge opening thereof For reference purposes both the infeed opening 54 and the discharge opening of the preferred rock crusher 30 have nominal dimensions of about 12 inch by 20 inch. Preferred exact dimensions of the housing of the preferred rock crusher 30 are illustrated in FIGS. 2-8, and Table 1.

Referring to FIG. 8 in particular, the first anvil set 44′ is mounted to the plate 48 of the preferred rock crusher 30 along a first plane which is represented by line “L1”. The second anvil set 44″ is mounted inside the door 56 of the preferred rock crusher 30 along a second plane which is represented by line “L2”. These first and second planes intersect each other along a line that passes along point “G”. Point “G” is at a distance “B3” of about 18⅛ inches above the center of the rotor 34, in line with the front part of the infeed opening 54, and vertically in line with the tip of a hammer 40 when the hammer bar 34 is positioned at its highest position.

Because the intersection point “G” is above the rotor 32 both the first and second anvil sets 44′, 44″ define a convex surface arrangement facing the rotor 32.

The third anvil set 44′″ is comprised of a single anvil bar that is mounted to the shelf 58 at an acute angle “B8” of about 10° from a horizontal diameter of the rotor 32 and at a slightly acute angle C3 of 86° from the plane of line L2 of the second anvil set 44″.

Both the second and third anvil sets 44″, 44″′ define a concave surface arrangement facing the rotor 32.

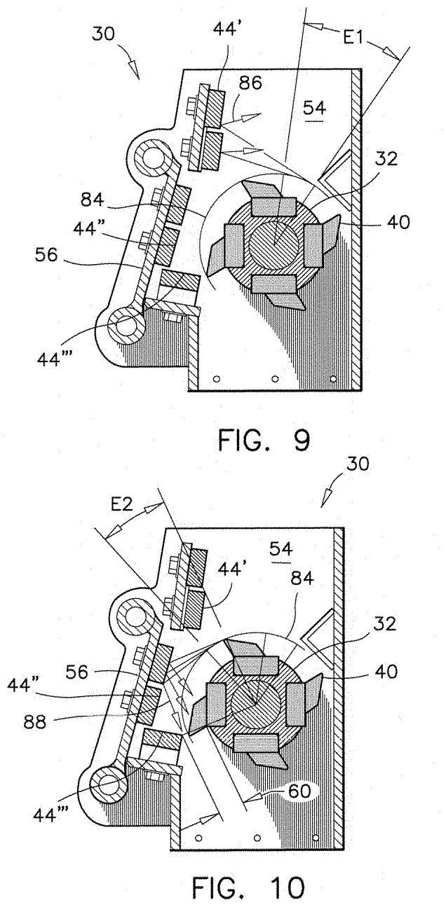

Because of the position and alignment of the anvil sets, three distinct regions are formed inside the preferred rock crusher 30. These regions are referred to herein as work sectors and will be described with reference to FIGS. 9, 10 and 11.

The first work sector is defined by angle “E1” in FIG. 9. Any rock or fragment of rocks that is projected from a tangent of the hammer swing circle 84 in the work sector associated with angle “E1” is projected against the first anvil set 44′ and deflected toward the infeed opening 54, as indicated by arrows 86.

The second work sector is defined by angle “E2” in FIG. 10. Any rock or fragment of rock that is projected from a tangent of the hammer swing circle 84 in the work sector associated with angle “E2” is projected against the second anvil set 44″ and deflected toward the discharge slot 60, between the hammers 40, as indicated by arrows 88 in FIG. 10.

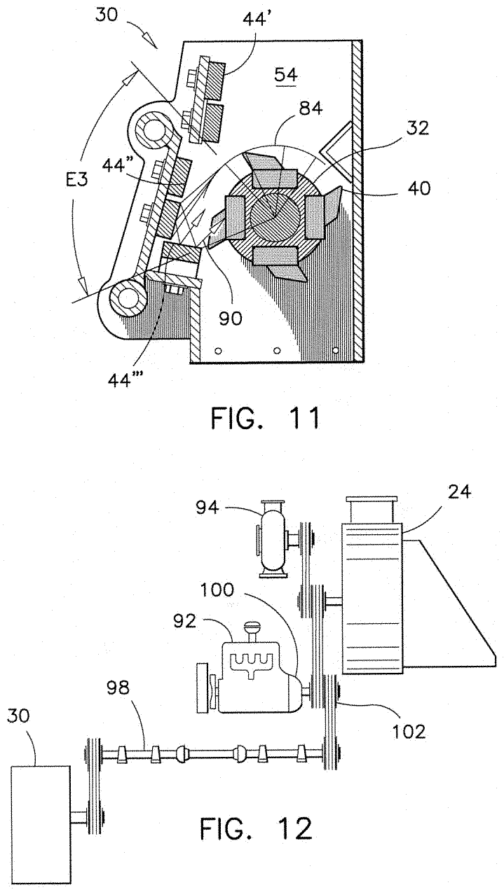

The third work sector is defined by angle “E3” in FIG. 11. The third work sector is the largest work sector. Any rock or fragment of rocks that are projected from a tangent of the hammer swing circle 84 in the work sector associated with angle “E3” is projected against the second anvil set 44″, deflected against the third anvil set 44″′, and deflected again head-on toward the hammer swing circle 84, as indicated by arrows 90.

It will be appreciated that arrows 86, 88 and 90 are reflections of their respective tangent lines intersecting respective surfaces of the respective anvil sets, as best explained by the drawings.

Rocks and rock fragments deflected toward the infeed opening 54 as in sector defined by “E1” cause the loosening up or decompression of the charge in the infeed opening 54 and on the rotor 32 of the crusher, for reducing friction and futile impacts in the infeed area 54.

Rocks and rock fragments deflected toward the discharge slot 60 as in sector defined by “E2” cause the loosening up or decompression of the charge in the crusher housing by timely discharging all rock fragments that have been reduced to an acceptable size. Again, this reduces friction on the rotor 32 and futile work by the rotor 32 of the rock crusher 30 inside the main body of the preferred rock crusher 30.

Rocks and rock fragments deflected toward the third anvil set 44″′ are deflected head-on toward the incoming hammers 40 for forceful impact against the moving hammers, as indicated by arrows 90. This work sector of high impact is represented by sector “E3” in FIG. 11. Again, this work sector “E3” is defined by tangents and rebounds from the work circle 84, and from the third anvil set 44″′. This sector “E3” is referred to herein as the high-impact work sector. This high-impact work sector “E3” accounts for 71°, or about one half of the total work sector “A1” of the rotor 32.

The effectiveness of this high-impact sector “E3” is enhanced by the loosening or decompression of the loading in the infeed chute by the effect of sector “E1” and by the loosening or decompression of the loading in the main body of the crusher and into the discharge opening by the effect of sector “E2”.

It is believed that the specific deflection of rocks in these regions and the reduction of friction and futile impacts contribute greatly to a better efficiency of this preferred rock crusher 30.

All three work sectors of the rotor 32 are contained within a total work sector “A1” as illustrated in FIG. 2 of 148°. Consequently, this relatively short overall work sector provides more frequent breaks between impacts for allowing the rotor 32 to recover its momentum.

The preferred rock crusher 30 is preferably operated at about 900 RPM. It is operated efficiently on a charge of rock of 1½ tons of rocks per hour, where each rock has a diameter of about 6 inches or less.

Although scientific corroboration of the efficiency of this rock crusher is not available, it is known that a precursor of this machine was separately driven by a dedicated 135 h.p. Now, the dedicated engine has been removed. The preferred rock crusher is driven by the same 115 h.p. engine 92 that is operating the potato harvester, without any reduction in the performance of the harvester.

Additionally, the aforementioned precursor of the preferred rock crusher has worn twenty-three sets of hammers and anvils during one season, while the preferred rock crusher 30 has worn only five (5) sets in one season.

Referring now to FIG. 12, the preferred drive system for the preferred rock crusher 30 is illustrated therein. The potato harvester 20 has a first fan 24 for creating a high flow of air to float potatoes across the aforesaid gap, and a small blower 94 to remove plant stocks, roots and foliage from the harvest. Both the fan 24 and blower 94 are connected to the same shaft 96 and this shaft is driven by belts from the engine 92. An auxiliary drive shaft 98 extends under the floor of the harvester, from the engine 92 to the rock crusher 30. This drive shaft 98 is also driven by belts from the engine 92 of the harvester. Although a clutch 100 is available in the bell housing of the engine 92, the drive shaft 98 and the fan 24 and blower 94 are directly connected to the same multi-belt pulley 102. As a consequence of this mounting, the inertia of the preferred rock crusher 30 is part of a larger inertia of the entire system. This larger common inertia contributes to achieve a better efficiency of the preferred rock crusher.

While one embodiment of the present invention has been illustrated in the accompanying drawings and described herein above, it will be appreciated by those skilled in the art that various modifications, alternate constructions and equivalents may be employed. Therefore, the above description and illustrations should not be construed as limiting the scope of the invention, which is defined in the appended claims.

What is claimed is:

1. A rock crusher comprising a casing, a rotor mounted in said casing, hammers mounted to said rotor and anvils mounted to said casing; said anvils comprising first, second and third anvil sets, and said first and second anvil sets defining a convex surface arrangement facing said rotor and said second and third anvil sets defining a concave surface arrangement facing said rotor.

2. The rock crusher as claimed in claim 1, wherein said first anvil set being oriented relative to a work circle of said rotor for projecting rocks toward an infeed portion of said rock crusher;
said second anvil set being oriented relative to said work circle of said rotor for projecting rocks toward a discharge opening of said rock crusher, and
said third anvils set being oriented relative to said work circle of said rotor for projecting rocks toward said work circle of said rotor of said rock crusher against a direction of rotation of said rotor.

3. The rock crusher as claimed in claim 1, wherein a plane of said first anvil set and a plane of said second anvil set intersect along a line above said rotor.

4. The rock crusher as claimed in claim 3, wherein said line is vertically inline with a tip of one of said hammers when said hammer is positioned at a highest portion on said rotor.

5. The rock crusher as claimed in claim 1, wherein said rotor has a work circle and a first tangent line between said work circle and said first anvil set has a first reflection toward an infeed portion of said casing.

6. The rock crusher as claimed in claim 5, wherein a second a tangent line between said work circle and said second anvil set has a second reflection toward a discharge slot of said casing.

7. The rock crusher as claimed in claim 6, wherein a third tangent line between said work circle and said second anvil set has a third reflection toward said third anvil set and a rebound from said third anvil set toward said work circle, against a direction of rotation of said rotor.

8. The rock crusher as claimed in claim 7 wherein said work circle comprises a work sector and said work sector is less than one half of said work circle.

9. The rock crusher as claimed in claim 8, wherein said third tangent line and said rebound are true along a portion of about one half of said work sector.

10. The rock crusher as claimed in claim 8, wherein said first and second tangent lines and first and second reflections are true before said third tangent line and said rebound, along said work circle, relative to a direction of rotation of said rotor.

11. The rock crusher as claimed in claim 8, wherein said first tangent line and first reflection are true along an angle of about 26° along said work circle, and said work sector has an angle of about 148° along said work circle.

12. The rock crusher as claimed in claim 11, wherein said second tangent line and second reflection are true along an angle of about 18° along said work circle.

13. A method of breaking rocks in a rock crusher, comprising in series, the steps of:
projecting rocks toward an infeed portion of said rock crusher;
projecting rocks toward a discharge opening of said rock crusher, and
projecting rocks toward a work circle of a rotor of said rock crusher against a direction of rotation of said rotor.

14. The method as claimed in claim 13, wherein a work sector of said rock crusher has an angle of about 148°, and said step of projecting rocks toward said infeed is true along a rotation of said rotor along a portion of about 26° along said work sector.

15. The method as claimed in claim 14, wherein said step of projecting rocks toward said discharge opening is true along a rotation of said rotor along a portion of about 26° along said work sector.

16. The method as claimed in claim 14, wherein said step of projecting rocks toward a work circle of a rotor of said rock crusher against a direction of rotation of said rotor is true along a rotation of said rotor along a portion of about 71° along said work sector.

17. A potato harvester comprising:
an engine;
a fan driven by said engine;
a drive shaft driven by said engine, and
a rock crusher driven by said drive shaft;
wherein said fan; said drive shaft and said rock crusher are directly driven by said engine and share with said engine a common inertia.

18. The potato harvester as claimed in claim 17, wherein said rock crusher comprises a rotor, and first, second and third anvil sets; and wherein said first anvil set being oriented relative to said rotor for projecting rocks toward an infeed portion of said rock crusher;
said second anvil set being oriented relative to said rotor for projecting rocks toward a discharge opening of said rock crusher, and
said third anvils set being oriented relative to said rotor for projecting rocks toward a work circle of said rotor of said rock crusher against a direction of rotation of said rotor.

19. The potato harvester as claimed in claim 18, wherein a work sector of said rock crusher has an angle of about 148°, and said first anvil set being oriented for projecting rocks toward said infeed portion during a rotation of about 26° of said rotor along said work sector.

20. The potato harvester as claimed in claim 18, wherein said second anvil set being oriented for projecting rocks toward said discharge opening during a rotation of about 18° of said rotor along said work sector; and said third anvil set being oriented for projecting rocks toward said work circle during a rotation of about 71° of said rotor along said work sector.
